(19) United States
(12) Patent Application Publication
(10) Pub. No.: US 2025/0227037 A1
(43) Pub. Date: Jul. 10, 2025

(54) NODE ELECTION VOTING METHODS AND APPARATUSES BASED ON CONSENSUS SYSTEM

(71) Applicant: Alipay (Hangzhou) Information Technology Co., Ltd., Hangzhou (CN)

(72) Inventors: Xiaojun LIAO, Hangzhou (CN); Meng ZHOU, Hangzhou (CN); Zigang ZHANG, Hangzhou (CN); Zhisong FU, Hangzhou (CN); Chuntao HONG, Hangzhou (CN)

(21) Appl. No.: 18/852,695

(22) PCT Filed: Mar. 31, 2023
(86) PCT No.: PCT/CN2023/085446

§ 371 Date: Sep. 30, 2024

(30) Foreign Application Priority Data
Apr. 2, 2022 (CN) 202210342797.8

(51) Int. Cl. H04L 41/00; H04L 43/0805

(52) U.S. Cl. CPC H04L 41/30; H04L 43/0805

(57) ABSTRACT

Embodiments of this specification provide node election voting methods and apparatuses based on a consensus system. The consensus system includes a first node device and a second node device, and a master node device. When determining that the master node device is not in a working state, the first node device sends a first pre-election message. When receiving the first pre-election message, the second node device stores the first pre-election message in a cache. When determining that the master node device is still in the working state, the second node device maintains a waiting state of the first pre-election message in the cache; and when determining that the master node device is not in the working state, the second node device sends a pre-voting message to the corresponding first node device, so that the first node device sends a formal first election message to another node device.

This application claims priority to Chinese Patent Application No. 2022103427978, filed with the China National Intellectual Property Administration on Apr. 2, 2022 and entitled “NODE ELECTION VOTING METHODS AND APPARATUSES BASED ON CONSENSUS SYSTEM”, which is incorporated herein by reference in its entirety.

### TECHNICAL FIELD

One or more embodiments of this specification relate to the field of computer technologies, and in particular, to node election voting methods and apparatuses based on a consensus system.

### BACKGROUND

In a distributed environment, such as application of a distributed database, it is often necessary to rely on distributed consistency protocols, such as the consensus protocol Raft, to achieve consistency between a plurality of pieces of copied data. Therefore, a consensus system can copy service data to different node devices through the consensus protocol to achieve consistency between a plurality of pieces of copied data, to obtain consensus data of a plurality of node devices, for example, a consensus process in a block chain network.

In the consensus system, a master node device can usually be responsible for connecting to external service requests, package the service requests, and copy packaged data to slave node devices to achieve consensus on the data. After consensus on the data is completed, all nodes execute the data obtained after consensus. Node devices participating in consensus are often deployed in a plurality of geographically different locations. However, distributed node devices usually face faults such as network isolation and process start/stop, which is prone to cause a short-term failure of communication between some node devices and other node devices, leading to consensus interruption. After network isolation is restored, the node devices rejoin the consensus system, which may cause unnecessary master node switching, affecting service request processing.

Therefore, an improved solution is expected to avoid unnecessary master node switching and improve rationality and completeness during master node election in the consensus system.

### SUMMARY

One or more embodiments of this specification describe node election voting methods and apparatuses based on a consensus system, to avoid unnecessary master node switching and improve rationality and completeness during master node election voting in a consensus system. Specific technical solutions are as follows.

According to a first aspect, one or more embodiments provide a node election voting method based on a consensus system, where the consensus system includes a plurality of node devices, the plurality of node devices include a master node device playing a master node role, and the method is performed by any second node device and includes:
receiving a first pre-election message sent by a first node device, where the first pre-election message is used to prepare for election of the master node role, and the first pre-election message is sent by the first node device when the first node device determines that the master node device is not in a working state;
storing the first pre-election message in a cache;
maintaining a waiting state of the first pre-election message in the cache when determining that the master node device is still in the working state; and
sending a pre-voting message to the corresponding first node device based on the first pre-election message in the cache when determining that the master node device is not in the working state, so that the first node device sends a first election message to another node device when receiving more than a first quantity of pre-voting messages.

In an implementation, the first pre-election message includes a first pre-election term and first latest consensus data, the first latest consensus data is data obtained after consensus between a plurality of node devices, and the first pre-election term is a term of the master node role that the first node device runs for; and the step of storing the first pre-election message in a cache includes:
storing the first pre-election message in the cache when determining that the first pre-election term and the first latest consensus data are newer than corresponding data in the second node device.

In an implementation, the method further includes:
discarding the first pre-election message when determining that the first pre-election term and the first latest consensus data are not newer than the corresponding data in the second node device.

In an implementation, the corresponding data in the second node device includes a current term and second latest consensus data, the current term is a term of the master node device stored in the second node device, and the second latest consensus data is latest consensus data stored in the second node device; and
that the first pre-election term and the first latest consensus data are newer than the corresponding data in the second node device includes the following cases:
the first pre-election term is higher than the current term, and the first latest consensus data is not earlier than the second latest consensus data; and
the first pre-election term is equal to the current term, and the first latest consensus data is later than the second latest consensus data.

In an implementation, the step of maintaining a waiting state of the first pre-election message in the cache includes:
maintaining the waiting state of the first pre-election message in the cache within first duration, where the first duration is greater than preset experience duration; and
the method further includes: discarding the first pre-election message when still determining that the master node device is in the working state until the first duration ends.

In an implementation, the following way is used to determine that the master node device is not in the working state:
determining whether an election timer of the second node device expires, if the election timer of the second node device expires, determining that the master node device is not in the working state, where the election timer is reset when a message is received from the master node device.

In an implementation, when corresponding first pre-election messages sent by several first node devices exist in the cache, the step of sending a pre-voting message to the corresponding first node device based on the first pre-election message in the cache includes:
sequentially sending, in an order of timestamps of the several first pre-election messages from early to late, the pre-voting message to the first node devices corresponding to the several first pre-election messages; or
determining a first pre-election message whose timestamp is the earliest from the several first pre-election messages, and sending the pre-voting message to a first node device corresponding to the first pre-election message whose timestamp is the earliest; or
sending the pre-voting message for the first pre-election message to the corresponding first node device based on priorities of the several first node devices.

In an implementation, the method further includes:
generating a second pre-election message when determining that the master node device is not in the working state; and sending the second pre-election message to another node device in the consensus system.

In an implementation, the step of generating a second pre-election message includes:
obtaining a term of the master node device stored in the second node device as a current term;
updating the current term to obtain a second pre-election term;
obtaining second latest consensus data stored in the second node vice; and
generating the second pre-election message that includes the second pre-election term and
the second latest consensus data.

In an implementation, after the sending the second pre-election message, the method further includes:
receiving a pre-voting message sent by the another node device for the second pre-election message;
sending a second election message to the another node device when a quantity of received pre-voting messages is greater than the first quantity;
receiving a voting message sent by the another node device for the second election message; and
determining a role of the second node device as the master node role when a quantity of received voting messages is greater than the first quantity.

In an implementation, the consensus system is a block chain network.

According to a second aspect, one or more embodiments provide a node election voting apparatus based on a consensus system, where the consensus system includes a plurality of node devices, the plurality of node devices include a master node device playing a master node role, and the apparatus is deployed in any second node device and includes:
a first receiving module, configured to receive a first pre-election message sent by a first node device, where the first pre-election message is used to prepare for election of the master node role, and the first pre-election message is sent by the first node device when the first node device determines that the master node device is not in a working state;
a first buffering module, configured to store the first pre-election message in a cache;
a first maintaining module, configured to maintain a waiting state of the first pre-election message in the cache when determining that the master node device is still in the working state; and
a first voting module, configured to send a pre-voting message to the corresponding first node device based on the first pre-election message in the cache when determining that the master node device is not in the working state, so that the first node device sends a first election message to another node device when receiving more than a first quantity of pre-voting messages.

In an implementation, the first pre-election message includes a first pre-election term and first latest consensus data, the first latest consensus data is data obtained after consensus between a plurality of node devices, and the first pre-election term is a term of the master node role that the first node device runs for; and
the first buffering module is specifically configured to store the first pre-election message in the cache when determining that the first pre-election term and the first latest consensus data are newer than corresponding data in the second node device.

In an implementation, the apparatus further includes:
a first generation module, configured to generate a second pre-election message when determining that the master node device is not in the working state; and
a first sending module, configured to send the second pre-election message to another node device in the consensus system.

In an implementation, the apparatus further includes:
a second receiving module, configured to receive a pre-voting message sent by the another node device for the second pre-election message after the second pre-election message is sent;
a second sending module, configured to send a second election message to the another node device when a quantity of received pre-voting messages is greater than the first quantity;
a third receiving module, configured to receive a voting message sent by the another node device for the second election message; and
a first determining module, configured to determine a role of the second node device as the master node role when a quantity of received voting messages is greater than the first quantity.

According to a third aspect, one or more embodiments provide a computer-readable storage medium. The computer-readable storage medium stores a computer program, and when the computer program is executed in a computer, the computer is enabled to perform the method in any implementation of the first aspect.

According to a fourth aspect, one or more embodiments provide a computing device, including a memory and a processor. The memory stores executable code, and when executing the executable code, the processor implements the method in any implementation of the first aspect.

In the method and the apparatus provided in the embodiments of this specification, when determining that the master node device is not in the working state, the first node device sends a pre-election message to another node device, and sends an election message only when receiving enough pre-voting messages, to start a formal election. This pre-election message mechanism can avoid unnecessary master node switching caused by direct election. In addition, when determining that the master node device is still in the working state, the first node device does not directly discard the pre-election message, but waits, and performs voting when determining that the master node device is not in the working state, which improves rationality and completeness during master node election voting in the consensus system.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description are merely some embodiments of this specification. A person of ordinary skill in the art can still derive other drawings from these accompanying drawings without creative efforts.

FIG. 1-1 is a schematic diagram illustrating an implementation scenario, according to one or more embodiments disclosed in this specification;

FIG. 1-2 is a schematic diagram illustrating another scenario in a consensus system;

FIG. 2 is a schematic flowchart illustrating a node election voting method based on a consensus system, according to one or more embodiments;

FIG. 3 is a schematic flowchart illustrating another node election voting method based on a consensus system, according to one or more embodiments; and

FIG. 4 is a schematic block diagram illustrating a node election voting apparatus based on a consensus system, according to one or more embodiments.

### DESCRIPTION OF EMBODIMENTS

The solutions provided in this specification are described below with reference to the accompanying drawings.

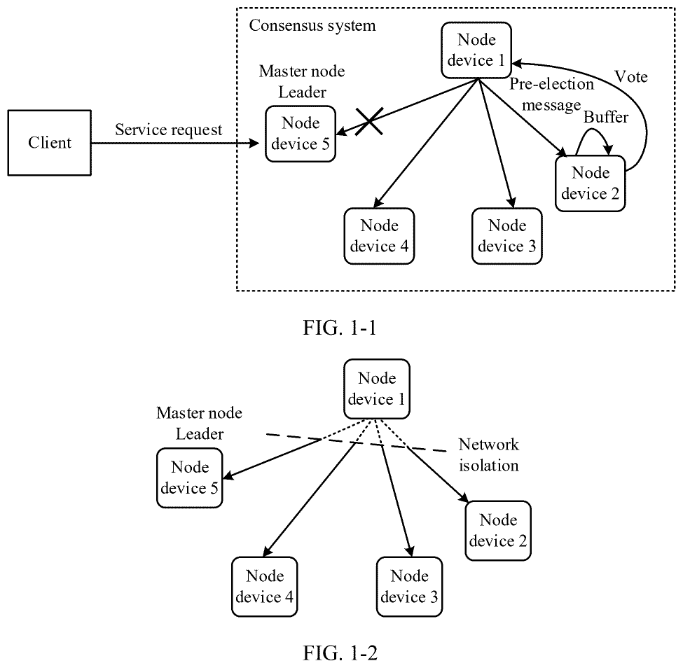

FIG. 1-1 is a schematic diagram illustrating an implementation scenario, according to one or more embodiments disclosed in this specification. A consensus system includes node device 1 to node device 5, and normally, the node devices can communicate with each other. Node device 5 plays a master node role (Leader), that is, serves as a master node device. The master node device periodically sends a message, so that other node devices perceive that the master node device is in a working state. When the master node device cannot work normally due to network isolation or another reason, the other node devices cannot receive the message sent by the master node device, and node device 1 to node device 4 start election timers with different duration. Assuming that the election timer of node device 1 first expires, node device 1 first perceives that the master node device does not exist (that is, is not in the working state), and sends a pre-election message to node device 2 to node device 4.

The following uses node device 2 as an example to describe a processing process performed when the node device receives the pre-election message. After receiving the pre-election message, node device 2 stores the pre-election message in a cache, and determines whether the master node device is still in the working state. If it is determined that the master node device is still in the working state, node device 2 maintains a waiting state of the pre-election message in the cache; and if it is determined that the master node device is not in the working state, node device 2 sends a pre-voting message for the pre-election message in the cache. In the plurality of node devices, the pre-election message of node device 1 is first sent to the other node devices, and node device 1 can first obtain pre-voting messages from the plurality of other node devices, so that node device 1 can initiate a formal election earlier to send a formal election message to the plurality of other node devices, and then be elected as the master node device. In FIG. 1-1, the node devices in the consensus system are merely examples. In actual application, a quantity of node devices in the consensus system can be any value greater than 2.

The consensus system in the one or more embodiments can be a system that provides a service. In the service provided, service request copies in a plurality of node devices in the consensus system need to be consistent to achieve data consensus, so that the plurality of node devices execute a service request in the consensus data. Therefore, all the node devices execute completely the same service request. In a process of consensus on a service request, when receiving a service request sent by a client, a master node device in the consensus system sends the service request as data to undergo consensus to all other node devices. The other node devices conduct a consistency vote on the received data based on their states. When receiving consistency voting messages from most of the node devices, the master node device sends information confirming that consistency is achieved to all the other node devices. As such, the data consensus process is completed. In this process, service requests in the plurality of node devices are consistent and completely the same. The consensus system can also receive a service request from a device other than the client, such as a server or another platform.

After achieving consistency on the data, that is, after obtaining consensus data obtained after consensus, the plurality of node devices can execute the service request in the consensus data by using state machines of the node devices, and record execution results in a service database.

In an application scenario, the consensus system can be a block chain network or another system that requires data consensus. The service request can be a transaction, for example, a transaction for transfer between different accounts. The service request can alternatively be another service request that needs to be executed synchronously in the consensus system, for example, can be a request used to update an association relationship between nodes in a graph database. The graph database is synchronously stored in a plurality of node devices, the graph database can be used to store the plurality of nodes and an association relationship between the nodes, and nodes in the graph database can represent users or merchants.

To better execute a service request, it is a very important step to achieve consensus on a service request between different node devices. The consensus system can copy the service request to different node devices by using a consensus protocol, for example, a consensus protocol such as Raft can be used. In the consensus step, a master node device plays a vital role. The one or more embodiments mainly discuss election and voting phases for a master node in the consensus system. The following uses the Raft protocol as an example to describe election of the master node.

In the consensus protocol Raft, a node device plays three roles: a master node role (Leader), a slave node role (Follower), and a candidate node role (Candidate). In each state, the node device executes a running program corresponding to the state. The master node device is generated through election. Each election of the master node device updates a term. Start of each term is one election of the master node. The master node device sends a heartbeat message or another message. When receiving the message from the master node device, a slave node device resets an election timer of the slave node device.

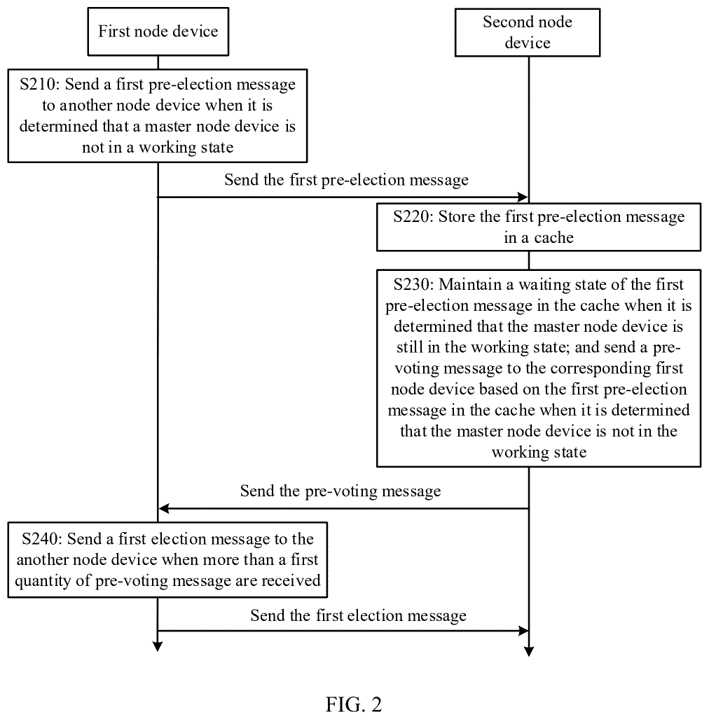

FIG. 1-2 is a schematic diagram illustrating another scenario in a consensus system. It is assumed that node device 1 serving as a slave node in FIG. 1-2 is in network isolation due to a fault of node device 1 or a network fault. When the election timer expires because node device 1 does not receive the message from the master node device, the node device adds a term of node device 1 by 1, and then broadcasts an election (vote) message to request everyone to select node device 1 as a master node. When network isolation of the node device is not restored, the election message cannot be sent. There may be a plurality of cases when node device 1 is in network isolation.

In a case, during network isolation, the master node device (node device 5) and other slave node devices (node device 2 to node device 4) continue to perform a consensus process, and consensus data is newer than consensus data in node device 1.

In a case, during network isolation, election is performed between the master node device and other slave node devices, the master node device is replaced, and a term is updated.

In a case, during network isolation, no election is performed between the master node device and other slave node devices, and a consensus process does not continue to be performed.

After node device 1 is released from network isolation, the election message of node device 1 can be successfully sent to other node devices. In the first two cases, because the term and the consensus data of node device 1 are not newer than those in the other node devices, the other node devices reject election of node device 1, and do not send voting messages to node device 1. If the master node device is still in the working state in this process, node device 1 receives the message from the master node device, returns to a slave node state, and stops election.

However, in the last case, the term of node device 1 is updated, and the consensus data has the same consistency as the consensus data in the other node devices and is not older. Therefore, the other node devices approve election of node device 1 and sends voting messages to node device 1, so that node device 1 becomes the master node device, which leads to unnecessary master node switching. In a master node switching process, a node device cannot process a service request, which also causes a delay in processing the service request.

To avoid unnecessary master node switching, one or more embodiments provide a node election voting method, including the following steps: Step S210: A first node device sends a first pre-election message to another node device when determining that a master node device is not in a working state, where the first pre-election message is used to prepare for election of a master node role. Step S220: Any second node device receives the first pre-election message sent by the first node device, and stores the first pre-election message in a cache. Step S230: The second node device maintains a waiting state of the first pre-election message in the cache when determining that the master node device is still in the working state. When determining that the master node device is not in the working state, the second node device sends a pre-voting message to the corresponding first node device based on the first pre-election message in the cache. Step S240: The first node device sends a first election message to the another node device when receiving more than a first quantity of pre-voting messages.

In the one or more embodiments, when determining that the master node device is not in the working state, the first node device sends a pre-election message rather than an election message to another node device, and then sends a formal election message when receiving a sufficient quantity of pre-voting messages from the node device. In addition, when receiving a pre-election message from another node device, the second node device stores the pre-election message in the cache, and votes for the pre-election message when determining that the master node device is not in the working state, to avoiding approving election when the master node device is still in the working state, leading to unnecessary master node switching. In the one or more embodiments, a pre-election mechanism is introduced to solve a problem that unnecessary master node switching occurs because a node rejoins a consensus network after transient isolation, and a problem of consensus interruption for a service request.

In addition, in another implementation scenario, for example, in the scenario shown in FIG. 1-1, the master node device is in network isolation due to a fault or another reason and is not in the working state. It is assumed that node device 1 does not receive the message from the master node device, and the election timer of node device 1 first expires (duration of election timers of different node devices is randomly determined). Therefore, node device 1 first sends a pre-election message to other slave node devices before the other node devices. When node devices such as node device 2 other than node device 1 receives the pre-election message from node device 1, because the election timer of node device 2 has not expired, etc., node device 2 does not consider that the master node device is faulty in this case. In this case, if node device 2 directly discards the pre-election message of node device 1, and other node devices may also discard the pre-election message of node device 1, node device 1 cannot be successfully elected as the master node device. As a result, a node device that first initiates election cannot be elected as the master node device.

In the one or more embodiments, when the second node device receives the first pre-election message, when determining that the master node device is still in the working state, the second node device does not directly discard the first pre-election message, but maintains the waiting state of the first pre-election message in the cache of the second node device; and when determining that the master node device is not in the working state, the second node device sends the pre-voting message for the first pre-election message, to avoid a problem that a node device that first initiates election cannot be elected as a master node.

The above-mentioned content is described with reference to the Raft protocol. However, improvements in the one or more embodiments are not limited to Raft. The improvements in the one or more embodiments can be applied to a protocol, provided that the protocol complies with the scenario in the one or more embodiments. The following further describes the one or more embodiments in detail with reference to FIG. 2.

FIG. 2 is a schematic flowchart illustrating a node election voting method based on a consensus system, according to one or more embodiments. The consensus system includes a plurality of node devices, and the node device can be implemented by any apparatus, device, platform, device cluster, etc. having a computing and processing capability. The plurality of node devices include a master node device playing a master node role, and can further include a slave node device playing a slave node role and a candidate node device playing a candidate node role. Each role is also referred to as a state. In different states, the node device runs a corresponding program in the state. The candidate node role is a role that prepares for election the master node role. The one or more embodiments are described with reference to the consensus system in FIG. 1-1. To describe an implementation process in the one or more embodiments more clearly, in the following, node device 1 represents a first node device, node device 2 represents a second node device, and node device 5 is a master node device. Node device 1 and node device 2 are any node devices in the consensus system.

In step S210, node device 1 sends a first pre-election message pre-votel to another node device when determining that the master node device is not in a working state. The another node device includes a node device other than node device 1 in the consensus system, for example, including node device 2 to node device 4 in FIG. 1-1. Node device 1 can send the first pre-election message pre-votel in the consensus system through broadcast.

The first pre-election message pre-votel is used to prepare for election of the master node role, and the first pre-election message is sent by node device 1 when node device 1 determines that the master node device is not in the working state. The first pre-election message is different from an election message, and the election message is used to formally run for the master node role. When receiving enough voting messages for the first pre-election message, node device 1 does not determine node device 1 as the master node device, and the voting messages are merely used to determine in advance how many node devices can support election of node device 1 as the master node device.

In an implementation, the first pre-election message pre-votel can include a first pre-election term term 1 and first latest consensus data Index1. The first pre-election term term 1 is a term of the master node role that node device 1 runs for. Each node device can store a term of a current master node device, and the term can be referred to as a current term. The term of the master node role that node device 1 runs for is newer than the current term. The first pre-election term term 1 can be represented by a number. The first latest consensus data Index1 is data obtained after consensus between a plurality of node devices, and each node device stores a plurality of pieces consensus data. The first latest consensus data is the latest consensus data in the plurality of pieces of consensus data in node device 1, and is also the newest consensus data. The first latest consensus data can be represented by an identifier of the consensus data. For example, a sequence number (Index) of the consensus data can be used as the identifier of the consensus data, and an order or a new or old state of the consensus data can be represented by the sequence number of the consensus data.

Node device 1 can determine, in the following way, that the master node device is not in the working state, determine whether an election timer of node device 1 expires, and if the election timer of the first node device expires, determine that the master node device is not in the working state. The election timer is reset when a message is received from the master node device, that is, the election timer in node device 1 is reset when node device 1 receives the message from the master node device. When receiving the message sent by the master node device, node device 1 can confirm that the master node device is still in the working state, and therefore resets the election timer to 0.

When it is determined that the master node device is not in the working state, the first pre-election message pre-votel can be generated, and the first pre-election message pre-votel is sent to another node device in the consensus system. When generating the first pre-election message pre-votel, node device 1 can perform the following step 1a to step 4a.

Step 1a: Obtain a term of the master node device stored in node device 1 as a current term.

Step 2a: Update the current term to obtain the first pre-election term term1. The current term can be specifically updated by adding a first preset value to the current term, to obtain the first pre-election term term1. For example, the first preset value can be an integer such as 1, 2, or 3. For example, the current term is 10, and the first pre-election term can be 11.

Step 3a: Obtain the first latest consensus data Index1 stored in node device 1. For example, when a sequence number of consensus data in the node device is determined in ascending order, consensus data with the largest sequence number can be used as the first latest consensus data Index1. Step 3a can be performed before or after step 1a.

Step 4a: Generate the first pre-election message pre-votel that includes the first pre-election term term 1 and the first latest consensus data Index1.

In step S220, node device 2 receives the first pre-election message pre-votel sent by node device 1, and stores the first pre-election message in a cache. In the one or more embodiments, only node device 2 is used as an example to describe a processing manner used when any node device receives a pre-election message sent by another node device, that is, storing the pre-election message in a cache.

When the first pre-election message pre-votel includes the first pre-election term term 1 and the first latest consensus data Index1, before storing the first pre-election message pre-votel in the cache, node device 2 can further determine whether the first pre-election term term 1 and the first latest consensus data Index1 are newer than corresponding data in node device 2.

When determining that the first pre-election term term 1 and the first latest consensus data Index1 are newer than the corresponding data in node device 2, node device 2 stores the first pre-election message pre-votel in the cache.

When determining that the first pre-election term term 1 and the first latest consensus data Index1 are not newer than the corresponding data in node device 2, node device 2 discards the first pre-election message pre-vote1.

The corresponding data in node device 2 can include a current term and second latest consensus data Index2. The current term is a term of the master node device stored in node device 2. The second latest consensus data Index2 is latest consensus data stored in node device 2, and is also data obtained after consensus between a plurality of node devices. The second latest consensus data Index2 is the latest consensus data in the plurality of pieces consensus data in node device 2, and is also the newest consensus data. The second latest consensus data Index2 can be represented by an identifier of the consensus data. For example, a sequence number of the consensus data can be used as the identifier of the consensus data, and an order or a new or old state of the consensus data can be represented by the sequence number of the consensus data.

That the first pre-election term term 1 and the first latest consensus data Index1 are newer than the corresponding data in node device 2 includes the following cases:

In one case, the first pre-election term term 1 is higher than the current term, and the first latest consensus data Index1 is not earlier than the second latest consensus data Index2, where the first latest consensus data Index1 can be equal to the second latest consensus data Index2, or can be later than the second latest consensus data Index2.

In another case, the first pre-election term term1 is equal to the current term, and the first latest consensus data Index1 is later than the second latest consensus data Index2.

When the first latest consensus data Index1 is equal to the second latest consensus data Index2, it indicates that the pieces of two data consensus are highly consistent. When the first latest consensus data Index1 is later than the second latest consensus data Index2, it indicates that the former is newer than the later and has higher consistency.

Generally, to ensure that an execution order of a service request is correct, a new term is set to be higher than an original term. When the new term is lower than the original term, it indicates that a device running for a master node may be a backward node, and other node devices cannot accept the backward node being elected as the master node device. Therefore, the first pre-election term term 1 should be higher than or equal to the current term.

In step S230, node device 2 maintains a waiting state of the first pre-election message pre-votel in the cache when determining that the master node device is still in the working state; and node device 2 sends a pre-voting message to the corresponding node device 1 based on the first pre-election message pre-votel in the cache when determining that the master node device is not in the working state. For example, the pre-voting message can be a message including “agree” information. After sending the pre-voting message, node device 2 can discard the first pre-election message pre-votel in the cache to save cache space.

Node device 2 can determine, in the following way, that the master node device is not in the working state:

Node device 2 determines whether an election timer of node device 2 expires, and if the election timer of the second node device expires, determines that the master node device is not in the working state. When determining that the election timer of node device 2 does not expire, node device 2 determines that the master node device is still in the working state.

The election timer is reset when a message is received from the master node device, that is, the election timer in node device 2 is reset by node device 2 when node device 2 receives the message from the master node device. When receiving the message sent by the master node device, node device 2 can confirm that the master node device is still in the working state, and therefore resets the election timer to 0. The message from the master node device includes a heartbeat message and a message including consensus data that are sent by the master node device, and further includes any other message. Any message can indicate that the master node device is still in the working state, provided that the message is sent by the master node device.

In the one or more embodiments, a pre-election message is stored in a cache of a node device, which can ensure that a node device that first initiates election is elected as a master node. For example, the master node device sends the heartbeat message to a slave node device every 10 ms, and a value of an election timer of the slave node device is randomly selected from a range of 100 ms to 2 s. When the master node device is in network isolation, assuming that duration of the election timer of node device 1 is 100 ms, the duration is the shortest, and therefore, the election timer first expires. Duration of the election timer of node device 2 is 2 s. When node device 2 receives the first pre-election message pre-votel from node device 1, because the election timer of node device 2 has not expired, node device 2 does not consider that the master node device is in network isolation. Node device 2 maintains the first pre-election message pre-votel in the cache, and can voter for node device 1 when the election timer expires.

That node device 2 maintains the waiting state of the first pre-election message pre-votel in the cache of node device 2 can be maintaining a storage state of the first pre-election message pre-votel in the cache of node device 2, and stores the first pre-election message pre-votel in the cache for specific duration. In an implementation, the waiting state of the first pre-election message pre-votel in the cache of node device 2 can be maintained within first duration. Within the first duration, it can be periodically determined, based on a preset periodicity, whether the master node device is still in the working state. If it is still determined that the master node device is in the working state until the first duration ends, the first pre-election message pre-votel is discarded.

The first duration is greater than preset experience duration, and the preset experience duration can be duration for a normal node to perceive that the master node device is in network isolation, or can be far greater than duration for releasing any node device from network isolation, or greater than a preset second quantity of periodicities. As such, node device 2 can discard the first pre-election message pre-votel when determining that the master node device is still in the working state within the second quantity of periodicities. Node device 2 can enable a waiting timer, and set duration of the waiting timer to the first duration.

For example, the master node device sends the heartbeat message to a slave node device every 10 ms, and a value of an election timer of the slave node device is randomly selected from a range of 100 ms to 2 s. The first duration can be longer than 2 s, so that the node device can have enough time to determine whether the master node device is really not in the working state.

Waiting duration of the first pre-election message pre-votel in the cache is set to avoid a case that the first pre-election message exists in the cache for a long time and occupies cache space. For example, it is assumed that the master node device is not in network isolation, but node device 1 is network isolation due to a fault or another reason (refer to the case in FIG. 1-2). After node device 1 is released from network isolation, node device 1 sends the first pre-election message pre-votel to another node device. In this case, node device 2 stores the first pre-election message pre-votel in the cache for the first duration. When determining that the master node device is still in the working state after the first duration ends, node device 2 can discard the first pre-election message pre-votel, and does not send a voting message to node device 1. As such, the cache is also cleared in time.

In an application scenario, after the master node device is in network isolation, election timers of a plurality of slave node devices successively expires to successively send pre-election messages.

Node device 2 is still used as an example. In step S230, when corresponding first pre-election messages pre-votel sent by several first node devices (for example, node device 1, node device 3, and node device 4) exist in the cache of node device 2, node device 2 can send the pre-voting message to the corresponding first node device based on the several first pre-election messages pre-votel in the cache.

In an implementation, node device 2 sequentially sends, in an order of timestamps of the several first pre-election messages from early to late, the pre-voting message to the first node devices corresponding to the several first pre-election messages. The pre-voting message can be set at intervals of specific duration. For example, after receiving pre-election messages respectively sent by node device 1, node device 3, and node device 4, node device 2 can first send the pre-voting message to node device 1, and send the pre-voting message to node device 3 after an interval of specific duration, and send the pre-voting message to node device 4 after another interval of specified duration. The pre-voting message does not directly lead to election of the master node device, and can only express a type of pre-approval, and therefore cannot cause confusion of master node election. On the contrary, sending the pre-voting message to a plurality of node devices can ensure that a node device is elected as a master node, to avoid a case that no node device is elected as the master node.

In an implementation, node device 2 can determine a first pre-election message with the earliest timestamp from the several first pre-election messages pre-votel, and send the pre-voting message to a first node device (for example, node device 1) corresponding to the first pre-election message with the earliest timestamp.

In an implementation, node device 2 sends the pre-voting message for the first pre-election message pre-votel to the corresponding first node device based on priorities of the several first node devices. The priority can be a priority of a geographic location, or can be a priority of a computing capability, etc. Node device 2 can select the corresponding first node device in descending order of the priorities, and send the pre-voting message to the corresponding first node device.

For example, the plurality of node devices are geographically distributed in different regions. In election of the master node device, a node device that is located in the same geographic region as the master node device can be preferably supported as the master node device. Alternatively, a node device with a higher computing capability is preferably supported as the master node device.

In step S240, the first node device, using node device 1 as an example, sends a first election message votel to the another node device when receiving more than a first quantity of pre-voting messages.

The first quantity can be preset, or can be determined based on a quantity of node devices in the consensus system. For example, in the Raft protocol, the first quantity can be set to half of a total quantity of node devices in the consensus system, or set to a value greater than that half. In the Raft protocol, the consensus system can run normally, provided that more than half of the node devices can participate in consensus.

One pre-voting message is sent by one node device, and n pre-voting messages are sent by n node devices. When n is greater than the first quantity, it indicates that more than the first quantity of node devices have sent the pre-voting message and agree to election of node device 1. When enough node devices approve election of node device 1, formal master node election can start, which can also ensure avoidance of unnecessary master node switching.

When generating the first election message votel, node device I can obtain a term of the master node device stored in node device 1 as a current term, update the current term to obtain a first pre-election term, obtain first latest consensus data stored in node device 1, and generate the first election message votel that includes the first pre-election term and the first latest consensus data. In other words, a term in a formal election message is determined by the current term. The current term can also be referred to as a service term.

The following goes back to step S210. When the election timer of node device 1 expires, the first pre-election message pre-votel is generated, and the first pre-election message pre-votel is sent to another node device. When the election timer of node device 1 expires again, node device 1 can continue to send the first pre-election message pre-votel to another node device without changing the first pre-election term term 1 included in the first pre-election message pre-votel.

In step S240, node device 1 may receive pre-voting messages whose quantity is less than or equal to the first quantity, or may not receive any pre-voting message at all. In this case, if the node device does not receive the message from the master node device, including messages from an original master node device and a newly elected master node device, the election timer of node device 1 expires again.

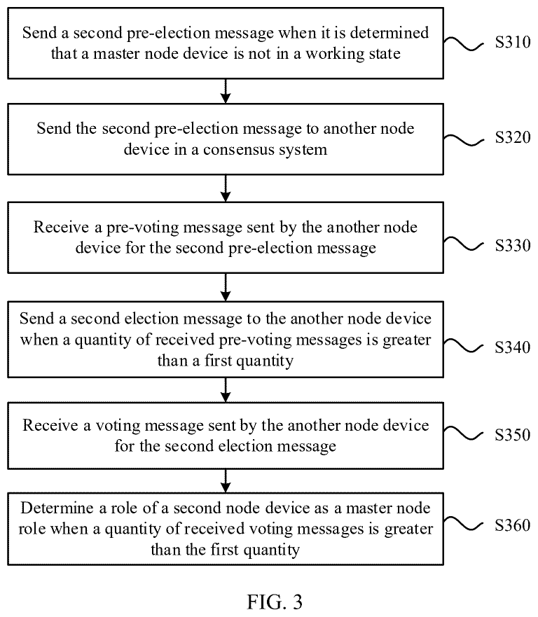

In other embodiments of this specification, when determining that the master node device is not in the working state in step S230, the second node device can further continue to perform the schematic flowchart shown in FIG. 3. FIG. 3 is a schematic flowchart illustrating another node election voting method based on a consensus system, according to one or more embodiments, where the method specifically includes the following step S310 to step S360 Node device 2 is still used to represent the second node device to provide description.

Step S310: Node device 2 generates a second pre-election message pre-vote2 when determining that the master node device is not in the working state. Node device 2 can generate the second pre-election message pre-vote2 by using the following step 1b to step 4b:

Step 1b: Obtain a term of the master node device stored in node device 2 as a current term.

Step 2b: Update the current term to obtain a second pre-election term term2. The current term can be specifically updated by adding a first preset value to the current term, to obtain the second pre-election term term2. For example, the first preset value can be an integer greater than 0.

Step 3b: Obtain second latest consensus data Index2 stored in node device 2. For example, when a sequence number of consensus data in the node device is determined in ascending order, consensus data with the largest sequence number can be used as the second latest consensus data Index2. Step 3b can be performed before or after step 1b.

Step 4b: Generate the second pre-election message pre-vote2 that includes the second pre-election term term2 and the second latest consensus data Index2.

Step S320: Node device 2 sends the second pre-election message pre-vote2 to another node device in the consensus system. The another node device is a node device other than node device 2 in the consensus system, for example, node device 1, node device 3, and node device 4 in FIG. 1-1.

Step S330: After sending the second pre-election message pre-vote2, node device 2 can further receive a pre-voting message sent by the another node device for the second pre-election message pre-vote2. A processing procedure performed after the another node device receives the second pre-election message pre-vote2 is similar to the processing procedure performed after node device 2 receives the first pre-election message pre-votel in FIG. 2. Details are not described herein again.

Step S340: Node device 2 sends a second election message vote2 to the another node device when a quantity of received pre-voting messages is greater than a first quantity. A process of generating the second election message vote2 by node device 2 is similar to the process of generating the first election message votel by node device 1. Details are not described herein again.

Step S350: Node device 2 receives a voting message sent by the another node device for the second election message vote2. The voting message can be a message including “agree” information.

Step S360: Determine a role of node device 2 as the master node role when a quantity of received voting messages is greater than the first quantity.

Review the above-mentioned step S330 to step S360 again. Node device 2 may receive no pre-voting message sent by the another node device for the second pre-election message pre-vote2, or may receive pre-voting messages whose quantity is not greater than the first quantity. Therefore, step S330 to step S360 are performed only when a condition is satisfied, and the condition that needs to be satisfied includes: the quantity of received pre-voting messages is greater than the first quantity, the quantity of received voting messages is greater than the first quantity, etc.

Review step S310 again. When the election timer of node device 2 expires, the second pre-election message pre-vote2 is generated, and the second pre-election message pre-vote2 is sent to another node device. When the election timer of node device 2 expires again, node device 2 can continue to send the second pre-election message pre-vote2 to another node device without changing the second pre-election term term2 included in the second pre-election message pre-vote2.

In this specification, words such as “first” in words such as a first node device, a first pre-election message, a first pre-election term, first latest consensus data, and a first election message and corresponding “second” in the context are merely intended to facilitate distinguishing and description, and have not limiting meaning.

Specific embodiments of this specification have been described above, and other embodiments fall within the scope of the appended claims. In some cases, actions or steps described in the claims can be performed in an order different from that in the embodiments and desired results can still be achieved. In addition, processes described in the accompanying drawings do not necessarily require a specific order or a sequential order shown to achieve the desired results. In some implementations, multitasking and parallel processing are also possible or may be advantageous.

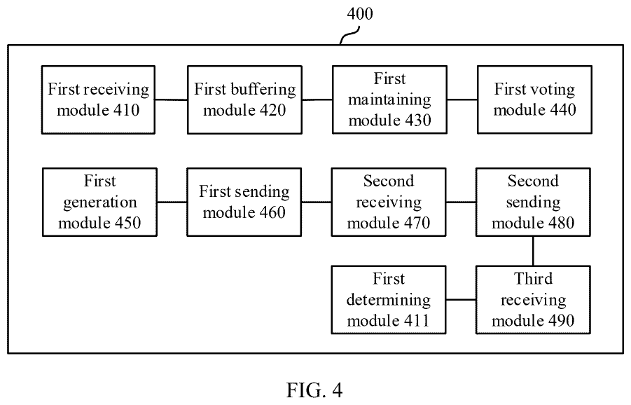

FIG. 4 is a schematic block diagram illustrating a node election voting apparatus based on a consensus system, according to one or more embodiments. The consensus system includes a plurality of node devices, and the node device can be implemented by any apparatus, device, platform, device cluster, etc. having a computing and processing capability. The plurality of node devices include a master node device playing a master node role. The apparatus embodiment correspond to the method embodiments shown in FIG. 2 and FIG. 3. The apparatus 400 is deployed in any second node device, and the apparatus 400 includes:
a first receiving module 410, configured to receive a first pre-election message sent by a first node device, where the first pre-election message is used to prepare for election of the master node role, and the first pre-election message is sent by the first node device when the first node device determines that the master node device is not in a working state;
a first buffering module 420, configured to store the first pre-election message in a cache;
a first maintaining module 430, configured to maintain a waiting state of the first pre-election message in the cache when determining that the master node device is still in the working state; and
a first voting module 440, configured to send a pre-voting message to the corresponding first node device based on the first pre-election message in the cache when determining that the master node device is not in the working state, so that the first node device sends a first election message to another node device when receiving more than a first quantity of pre-voting messages.

In an implementation, the first pre-election message includes a first pre-election term and first latest consensus data, the first latest consensus data is data obtained after consensus between a plurality of node devices, and the first pre-election term is a term of the master node role that the first node device runs for; and
the first buffering module 420 is specifically configured to:
store the first pre-election message in the cache when determining that the first pre-election term and the first latest consensus data are newer than corresponding data in the second node device.

In an implementation, the apparatus 400 further includes:
a first discarding module (not shown in the figure), configured to discard the first pre-election message when determining that the first pre-election term and the first latest consensus data are not newer than the corresponding data in the second node device.

In an implementation, the corresponding data in the second node device includes a current term and second latest consensus data, the current term is a term of the master node device stored in the second node device, and the second latest consensus data is latest consensus data stored in the second node device; and
that the first pre-election term and the first latest consensus data are newer than the corresponding data in the second node device includes the following cases:
the first pre-election term is higher than the current term, and the first latest consensus data is not earlier than the second latest consensus data; and
the first pre-election term is equal to the current term, and the first latest consensus data is later than the second latest consensus data.

In an implementation, the first maintaining module 430 is specifically configured to:
maintain the waiting state of the first pre-election message in the cache within first duration, where the first duration is greater than preset experience duration; and the apparatus 400 further includes:
a second discarding module (not shown in the figure), configured to discard the first pre-election message when still determining that the master node device is in the working state until the first duration ends.

In an implementation, the apparatus 400 further includes a first determining module (not shown in the figure), configured to determine, in the following way, that the master node device is not in the working state:
determining whether an election timer of the second node device expires, if the election timer of the second node device expires, determining that the master node device is not in the working state, where the election timer is reset when a message is received from the master node device.

In an implementation, the first voting module 440 is specifically configured to: when corresponding first pre-election messages sent by several first node devices exist in the cache, sequentially send, in an order of timestamps of the several first pre-election messages from early to late, the pre-voting message to the first node devices corresponding to the several first pre-election messages; or
the first voting module 440 is specifically configured to: when corresponding first pre-election messages sent by several first node devices exist in the cache, determine a first pre-election message whose timestamp is the earliest from the several first pre-election messages, and send the pre-voting message to a first node device corresponding to the first pre-election message whose timestamp is the earliest; or
the first voting module 440 is specifically configured to: when corresponding first pre-election messages sent by several first node devices exist in the cache, send the pre-voting message for the first pre-election message to the corresponding first node device based on priorities of the several first node devices.

In an implementation, the apparatus 400 further includes:
a first generation module 450, configured to generate a second pre-election message when determining that the master node device is not in the working state; and
a first sending module 460, configured to send the second pre-election message to another node device in the consensus system.

In an implementation, the first generation module 450 includes:
a first acquisition submodule (not shown in the figure), configured to obtain a term of the master node device stored in the second node device as a current term;
a first updating submodule (not shown in the figure), configured to update the current term to obtain a second pre-election term;
a second acquisition submodule (not shown in the figure), configured to obtain second latest consensus data stored in the second node device; and
a first generation submodule (not shown in the figure), configured to generate the second pre-election message that includes the second pre-election term and the second latest consensus data.

In an implementation, the apparatus 400 further includes:
a second receiving module 470, configured to receive a pre-voting message sent by the another node device for the second pre-election message after the second pre-election message is sent;
a second sending module 480, configured to send a second election message to the another node device when a quantity of received pre-voting messages is greater than the first quantity;
a third receiving module 490, configured to receive a voting message sent by the another node device for the second election message; and
a first determining module 411, configured to determine a role of the second node device as the master node role when a quantity of received voting messages is greater than the first quantity.

The above-mentioned apparatus embodiments correspond to the method embodiments. For detailed descriptions, references can be made to the descriptions of the method embodiments. Details are omitted here for simplicity. The apparatus embodiments are obtained based on the corresponding method embodiments, and have the same technical effects as the corresponding method embodiments. For detailed descriptions, references can be made to the corresponding method embodiments.

One or more embodiments of this specification further provide a computer-readable storage medium. The computer-readable storage medium stores a computer program, and when the computer program is executed in a computer, the computer is enabled to perform the method in any of FIG. 1 to FIG. 3.

One or more embodiments of this specification further provide a computing device, including a memory and a processor. The memory stores executable code, and when executing the executable code, the processor implements the method in any of FIG. 1 to FIG. 3.

The embodiments of this specification are described in a progressive way. For the same or similar parts of the embodiments, mutual references can be made between the embodiments. Each embodiment focuses on a difference from other embodiments. Particularly, the embodiments of the storage medium and the computing device are basically similar to the method embodiments, and therefore are described briefly. For related parts, references can be made to some descriptions in the method embodiments.

A person skilled in the art should be aware that, in the above-mentioned one or more examples, functions described in the embodiments of this application can be implemented by hardware, software, firmware, or any combination thereof. When the functions are implemented by software, the functions can be stored in a computer-readable medium or transmitted as one or more instructions or code on the computer-readable medium.

The above-mentioned specific implementations further describe in detail the objectives, technical solutions, and beneficial effects of the embodiments of this application. It should be understood that, the above-mentioned descriptions are merely specific implementations of the embodiments of this specification, and are not intended to limit the protection scope of this specification. Any modification, equivalent replacement, or improvement made on the basis of the technical solutions in this specification shall fall within the protection scope of this specification.

1. A node election voting method based on a consensus system, wherein the consensus system comprises a plurality of node devices, the plurality of node devices comprise a master node device playing a master node role, and the method is performed by any second node device and comprises:
receiving a first pre-election message sent by a first node device, wherein the first pre-election message is used to prepare for election of the master node role, and the first pre-election message is sent by the first node device when the first node device determines that the master node device is not in a working state;
storing the first pre-election message in a cache;
maintaining a waiting state of the first pre-election message in the cache when determining that the master node device is still in the working state; and
sending a pre-voting message to the corresponding first node device based on the first pre-election message in the cache when determining that the master node device is not in the working state, so that the first node device sends a first election message to another node device when receiving more than a first quantity of pre-voting messages.

2. The method according to claim 1, wherein the first pre-election message comprises a first pre-election term and first latest consensus data, the first latest consensus data is data obtained after consensus between a plurality of node devices, and the first pre-election term is a term of the master node role that the first node device runs for; and
the step of storing the first pre-election message in a cache comprises:
storing the first pre-election message in the cache when determining that the first pre-election term and the first latest consensus data are newer than corresponding data in the second node device.

3. The method according to claim 2, further comprising:
discarding the first pre-election message when determining that the first pre-election term and the first latest consensus data are not newer than the corresponding data in the second node device.

4. The method according to claim 2, wherein the corresponding data in the second node device comprises a current term and second latest consensus data, the current term is a term of the master node device stored in the second node device, and the second latest consensus data is latest consensus data stored in the second node device; and
that the first pre-election term and the first latest consensus data are newer than the corresponding data in the second node device comprises the following cases:
the first pre-election term is higher than the current term, and the first latest consensus data is not earlier than the second latest consensus data; and
the first pre-election term is equal to the current term, and the first latest consensus data is later than the second latest consensus data.

5. The method according to claim 1, wherein the step of maintaining a waiting state of the first pre-election message in the cache comprises:
maintaining the waiting state of the first pre-election message in the cache within first duration, wherein the first duration is greater than preset experience duration; and
the method further comprises:
discarding the first pre-election message when still determining that the master node device is in the working state until the first duration ends.

6. The method according to claim 1, wherein the following way is used to determine that the master node device is not in the working state:
determining whether an election timer of the second node device expires, upon determining that the election timer of the second node device expires, determining that the master node device is not in the working state, wherein the election timer is reset when a message is received from the master node device.

7. The method according to claim 1, wherein when corresponding first pre-election messages sent by several first node devices exist in the cache, the step of sending a pre-voting message to the corresponding first node device based on the first pre-election message in the cache comprises:
sequentially sending, in an order of timestamps of the several first pre-election messages from early to late, the pre-voting message to the first node devices corresponding to the several first pre-election messages; or
determining a first pre-election message whose timestamp is the earliest from the several first pre-election messages, and sending the pre-voting message to a first node device corresponding to the first pre-election message whose timestamp is the earliest; or sending the pre-voting message for the first pre-election message to the corresponding first node device based on priorities of the several first node devices.

8. The method according to claim 1, further comprising:
generating a second pre-election message when determining that the master node device is not in the working state; and
sending the second pre-election message to another node device in the consensus system.

9. The method according to claim 8, wherein the step of generating a second pre-election message comprises:
obtaining a term of the master node device stored in the second node device as a current term;
updating the current term to obtain a second pre-election term;
obtaining second latest consensus data stored in the second node vice; and
generating the second pre-election message that comprises the second pre-election term and the second latest consensus data.

10. The method according to claim 8, after the sending the second pre-election message, further comprising:
receiving a pre-voting message sent by the another node device for the second pre-election message;
sending a second election message to the another node device when a quantity of received pre-voting messages is greater than the first quantity;
receiving a voting message sent by the another node device for the second election message; and
determining a role of the second node device as the master node role when a quantity of received voting messages is greater than the first quantity.

11. The method according to claim 1, wherein the consensus system is a block chain network.

12. (canceled)

13. (canceled)

14. (canceled)

15. (canceled)

16. A non-transitory computer-readable storage medium, wherein the computer-readable storage medium stores a computer program, and when the computer program is executed in a computer, the computer is enabled to perform a node election voting method based on a consensus system, wherein the consensus system comprises a plurality of node devices, the plurality of node devices comprise a master node device playing a master node role, and the method is performed by any second node device and comprises:
receiving a first pre-election message sent by a first node device, wherein the first pre-election message is used to prepare for election of the master node role, and the first pre-election message is sent by the first node device when the first node device determines that the master node device is not in a working state;
storing the first pre-election message in a cache;
maintaining a waiting state of the first pre-election message in the cache when determining that the master node device is still in the working state; and
sending a pre-voting message to the corresponding first node device based on the first pre-election message in the cache when determining that the master node device is not in the working state, so that the first node device sends a first election message to another node device when receiving more than a first quantity of pre-voting messages.

17. A computing device, comprising a memory and a processor, wherein the memory stores executable code, and when executing the executable code, the processor implements a node election voting method based on a consensus system, wherein the consensus system comprises a plurality of node devices, the plurality of node devices comprise a master node device playing a master node role, and the method is performed by any second node device and comprises:
receiving a first pre-election message sent by a first node device, wherein the first pre-election message is used to prepare for election of the master node role, and the first pre-election message is sent by the first node device when the first node device determines that the master node device is not in a working state;
storing the first pre-election message in a cache;
maintaining a waiting state of the first pre-election message in the cache when determining that the master node device is still in the working state; and
sending a pre-voting message to the corresponding first node device based on the first pre-election message in the cache when determining that the master node device is not in the working state, so that the first node device sends a first election message to another node device when receiving more than a first quantity of pre-voting messages.

18. The computing device according to claim 17, wherein the first pre-election message comprises a first pre-election term and first latest consensus data, the first latest consensus data is data obtained after consensus between a plurality of node devices, and the first pre-election term is a term of the master node role that the first node device runs for; and
Wherein the computing device being caused to store the first pre-election message in a cache includes being caused to:
store the first pre-election message in the cache when determining that the first pre-election term and the first latest consensus data are newer than corresponding data in the second node device.

19. The computing device according to claim 18, wherein the computing device is further caused to:
discard the first pre-election message when determining that the first pre-election term and the first latest consensus data are not newer than the corresponding data in the second node device.

20. The computing device according to claim 18, wherein the corresponding data in the second node device comprises a current term and second latest consensus data, the current term is a term of the master node device stored in the second node device, and the second latest consensus data is latest consensus data stored in the second node device; and
the first pre-election term and the first latest consensus data are newer than the corresponding data in the second node device comprises the following cases:
the first pre-election term is higher than the current term, and the first latest consensus data is not earlier than the second latest consensus data; and
the first pre-election term is equal to the current term, and the first latest consensus data is later than the second latest consensus data.

21. The computing device according to claim 17, wherein the computing device being caused to maintain a waiting state of the first pre-election message in the cache includes being caused to:
maintain the waiting state of the first pre-election message in the cache within first duration, wherein the first duration is greater than preset experience duration; and
the computing device is further caused to:
discard the first pre-election message when still determining that the master node device is in the working state until the first duration ends.

22. The computing device according to claim 17, wherein the computing device is further caused to:
generate a second pre-election message when determining that the master node device is not in the working state; and
send the second pre-election message to another node device in the consensus system.

23. The computing device according to claim 22, wherein the computing device being caused to generate a second pre-election message includes being caused to:
obtain a term of the master node device stored in the second node device as a current term;
update the current term to obtain a second pre-election term;
obtain second latest consensus data stored in the second node vice; and
generate the second pre-election message that comprises the second pre-election term and the second latest consensus data.

24. The computing device according to claim 22, wherein after the sending the second pre-election message, the computing device is further caused to:
receive a pre-voting message sent by the another node device for the second pre-election message;
send a second election message to the another node device when a quantity of received pre-voting messages is greater than the first quantity;
receive a voting message sent by the another node device for the second election message; and
determine a role of the second node device as the master node role when a quantity of received voting messages is greater than the first quantity.
